(19) United States
(12) Patent Application Publication
(10) Pub. No.: US 2022/0196323 A1
(43) Pub. Date: Jun. 23, 2022

(54) Cryogenic Containment System

(71) Applicant: Caterpillar Inc., Peoria, IL (US)

(72) Inventors: David Montgomery, Edelstein, IL (US); David M. Ginter, Peoria, IL (US)

(73) Assignee: Caterpillar Inc., Peoria, IL (US)

(21) Appl. No.: 17/153,648

(22) Filed: Jan. 20, 2021

Related U.S. Application Data
(60) Provisional application No. 63/129,541, filed on Dec. 22, 2020.

(51) Int. Cl. F25J 1/02; F17C 7/04; F17C 13/02; F25J 1/00

(52) U.S. Cl. CPC F25J 1/0227; F25J 2210/90; F17C 13/026; F17C 13/025; F25J 1/001; F25J 1/0254; F17C 2221/012; F17C 2223/0161; F17C 2227/0337; F17C 2265/031; F17C 2250/0439; F17C 2250/043; F17C 2250/03; F25J 2270/912; F25J 2290/62; F17C 7/04

(57) ABSTRACT

A cryogenic fluid containment system is disclosed. The system can store a fluid such as hydrogen at a cryogenic temperature and pressure. As the fluid naturally warms, the fluid can be directed to a portion of a liquefaction system that is configured to perform a cooling technique on the fluid. The cooling techniques may be Joule-Thomson cooling techniques. The liquefaction system may be equipped to perform both non-Joule-Thomson cooling techniques and Joule-Thomson cooling techniques. The system is configured to direct fluid to an appropriate portion of the liquefaction system, which may be based at least in part upon a Joule-Thomson coefficient of the fluid.

### CROSS-REFERENCE TO RELATED APPLICATIONS

This application claims priority to and is a non-provisional of U.S. Patent Application No. 63/129,541, filed Dec. 22, 2020, entitled “Cryogenic Containment System,” the disclosure of which is incorporated by reference herein in its entirety for all purposes.

### TECHNICAL FIELD

The present disclosure relates to systems and methods for handling fluids at cryogenic temperatures and pressures. More specifically, the present disclosure relates to systems and methods for reducing or eliminating boil-off waste.

### BACKGROUND

Large-scale facilities such as data centers consume large amounts of energy and require backup equipment to ensure there is enough power to complete essential tasks in the event of power loss. Conventionally, diesel generator sets or “gensets” are used to provide backup power to large-scale facilities. Increasingly, hydrogen fuel cells and engines are being considered for this purpose, but they present their own challenges. The fuel for such engines is stored at cryogenic temperatures and pressures until the backup power is needed. Cryogenic fluids are typically stored in tanks that passively maintain the stored fluids at extremely cold temperatures. In most cases it is considered inefficient to actively cool the fluids stored within such passive storage tanks, and as a result, other systems are often used to cool these fluids before they are put into the tanks. Passive storage tanks are of course imperfect, and the cryogenic fluid stored within such tanks will warm and increase in pressure gradually over time. When such warming occurs, at least some of the stored hydrogen will need to be released as “boil-off” in order to maintain safe pressure in the tanks. It should be noted that boil-off refers to the natural process where an amount of cryogenic fluid changes from a liquid phase to a gas phase as the temperature inside the storage tank rises. In some conventional systems, the amount of cryogenic fluid that experiences the phase change from liquid to gas provides the passive cooling of the cryogenic fluid as the latent heat of vaporization absorbs thermal energy within the system. As this happens, the gas generated via boil-off can be vented into the atmosphere to maintain safe storage pressures. In some systems, hydrogen may boil-off at a rate of up to 1% per day or more. In such systems, hydrogen will need to be completely replaced approximately every 100 days unless a process is employed to capture and at least partly reuse the boil-off.

One system for converting a boil-off stream of a cryogenic fluid is disclosed in U.S. Pat. No. 6,672,104 (hereinafter referred to as “the '104 reference”). The '104 reference discloses pressurizing a boil-off stream, cooling the pressurized boil-off stream, and then expanding the boil-off stream. As explained in the '104 reference, expanding the boil-off stream further cools and at least partially liquefies the boil-off stream. The '104 reference discloses a preselected bubble point temperature of the resulting pressurized liquid that is obtained by removing, from the boil-off stream, a first predetermined amount of one or more components having a vapor pressure greater than the vapor pressure of the stored cryogenic fluid. In order to obtain the preselected bubble point temperature, the '104 reference also describes adding, to the boil-off stream, a second predetermined amount of one or more additives having a molecular weight heavier than the molecular weight of the stored cryogenic fluid and having a vapor pressure less than the vapor pressure of the stored fluid.

Although the system described in the '104 reference may be configured to controllably convert a boil-off stream of a stored cryogenic fluid, the system requires the use of multiple components dedicated to pressurizing, cooling, and expanding the stored fluid. Such components increase the cost and complexity of the system. Additionally, such components are prone to failure overtime. Thus, the system described in the '104 reference, and other similar systems, typically incur elevated maintenance costs associated with repairing and/or replacing such components, and also suffer from inefficiencies related to corresponding maintenance downtime.

Examples of the present disclosure are directed toward overcoming one or more of the deficiencies noted above.

### SUMMARY OF THE INVENTION

Examples of the present disclosure are directed to a system that includes a storage tank configured to store cryogenic hydrogen in a two-phase mixture, a liquefaction system, and a boil-off loop. In particular, the liquefaction system can include a Joule-Thomson cooling stage and a non-Joule-Thomson cooling stage fluidly connected to the Joule-Thomson cooling stage. Additionally, the liquefaction system can be configured to receive hydrogen from an external source, receive the hydrogen at the non-Joule-Thomson cooling stage, cool the hydrogen, at the non-Joule-Thomson cooling stage, to a first temperature below a temperature threshold, transfer the hydrogen at the first temperature from the non-Joule-Thomson cooling stage to the Joule-Thomson cooling stage, cool the hydrogen, at the Joule-Thomson cooling stage, to a second temperature less than the first temperature, and transfer the hydrogen at the second temperature from the Joule-Thomson cooling stage to the storage tank. Further, the boil-off loop can be configured to transfer boil-off hydrogen from the storage tank to the Joule-Thomson cooling stage of the liquefaction system. Accordingly, the Joule-Thomson cooling stage can be configured to cool the boil-off hydrogen to a third temperature and transfer the cooled boil-off hydrogen, at the third temperature, to the storage tank.

Further examples of the present disclosure are directed to a system that includes a storage tank, a liquefaction system, and a controller. In particular, the storage tank can be configured to store a fluid, in a cryogenic state, below a cryogenic temperature threshold and below a cryogenic pressure threshold. Additionally, the liquefaction system can include a first stage and a second stage fluidly connected to the first stage. Additionally, the liquefaction system can be configured to receive the fluid at the first stage, reduce a temperature of the fluid to a storage temperature below the cryogenic temperature threshold, and transfer the fluid, at the storage temperature and via a first fluid passage, from the second stage to the storage tank. In some examples, a second fluid passage can fluidly connect the storage tank with the second stage. Further, the controller can be operably connected to the liquefaction system and to one or more fluid control devices, wherein the controller is configured to: cause the one or more fluid control devices to transfer boil-off fluid from the storage tank to the second stage of the liquefaction system, cause the second stage of the liquefaction system to liquefy the boil-off fluid, and cause the one or more flow control devices to transfer the liquified boil-off fluid from the second stage of the liquefaction system to the storage tank.

Still further examples of the present disclosure are directed to a method that includes determining, with a first sensor associated with a storage tank, a temperature of hydrogen stored within the storage tank and determining, with a second sensor associated with the storage tank, a pressure of the hydrogen. Additionally, the method can include determining, with a controller operably connected to the first sensor and the second sensor, at least one of: the temperature of the hydrogen exceeds a temperature threshold and the pressure of the hydrogen exceeds a pressure threshold. Further, the method can include causing, with the controller and based at least in part on determining the at least one of the temperature of the hydrogen exceeds the temperature threshold and the pressure of the hydrogen exceeds the pressure threshold, a first flow control device operably connected to the controller to direct boil-off hydrogen from the storage tank to a liquefaction system fluidly connected to the storage tank. The liquefaction system can include a first stage configured to execute non-Joule-Thomson cooling techniques and a second stage fluidly connected to the first stage, the second stage being configured to execute Joule-Thomson cooling techniques. Accordingly, the method can include causing, with the controller, a second flow control device operably connected to the controller to transfer liquid hydrogen from the second stage of the liquefaction system to the storage tank.

### BRIEF DESCRIPTION OF THE DRAWINGS

FIG. 1 is a schematic illustration of a power system for a large-scale facility according to examples of the present disclosure.

FIG. 2 is a schematic illustration of a cryogenic containment system associated with the power system of FIG. 1 according to examples of the present disclosure.

FIG. 3 is a schematic illustration of a cryogenic containment system associated with the power system of FIG. 1 according to further examples of the present disclosure.

FIG. 4 is a schematic illustration of a multi-stage liquefaction system according to further examples of the present disclosure.

FIG. 5 is a block diagram illustrating a method according to examples of the present disclosure.

FIG. 6 is a block diagram illustrating a method according to further examples of the present disclosure in which a single liquefaction stage is used for boil-off purposes.

### DETAILED DESCRIPTION

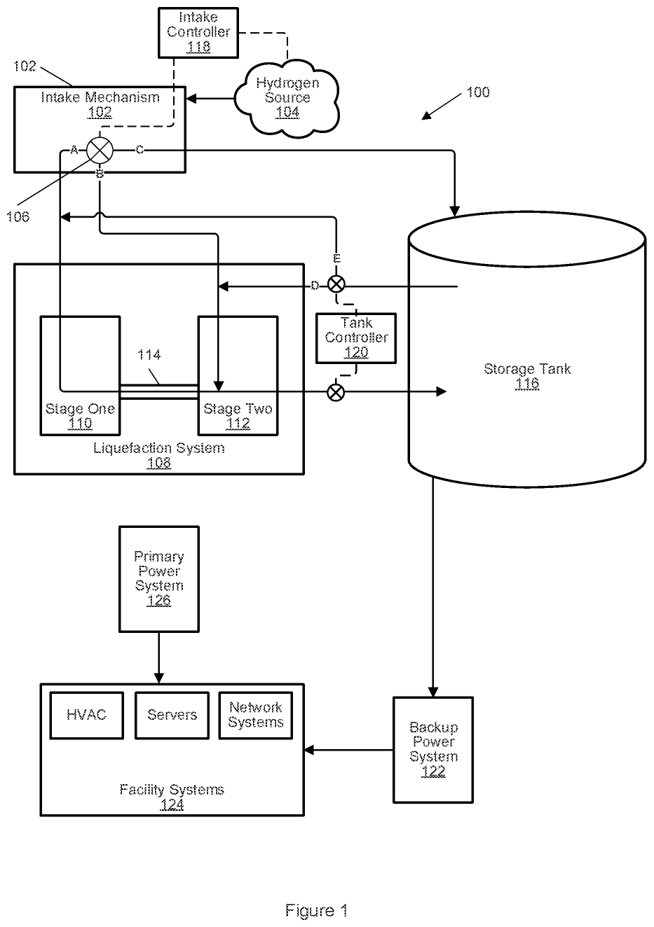

FIG. 1 is a schematic illustration of a cryogenic fluid boil-off mitigation system 100 according to embodiments of the present disclosure. The cryogenic fluid boil-off mitigation system 100 can be used with any fluid in any phase or combination of phases, and at a variety of temperatures and pressures depending on the particular application of the fluid and the type of fluid as each case may require. Hydrogen is one such fluid that can be stored and maintained by the cryogenic fluid boil-off mitigation system 100. It is to be appreciated that other fluids may also be used with the cryogenic fluid boil-off mitigation system 100 according to the present disclosure, and that any specific reference to hydrogen does not limit the scope of the present disclosure to any fluid type. For example, cryogenic fluids can include methane, carbon dioxide, nitrogen helium, noble gases, and other elements/compounds.

Hydrogen can present certain challenges for storage. For instance, hydrogen is volatile, and the liquefaction temperature is low (approximately 33 degrees Kelvin). As such, it can be difficult to maintain the hydrogen in a safe, efficient way so that it can be used as fuel or in other applications. Naturally, in any storage system there is a tendency for the hydrogen to warm and even vaporize. As this happens, an internal pressure of a tank increases and, if left unchecked, will exceed containment measures. Accordingly, the internal pressure can cause the tank to rupture and lead to damage to the surround facility, equipment, personnel, and/or assets. In some cases the vaporized hydrogen can be allowed to vent to the atmosphere to maintain pressure levels. Alternatively, or in addition, the cryogenic fluid boil-off mitigation system 100 can mitigate the losses associated with venting the stored hydrogen (or cryogenic fluid) to the atmosphere and can also address the problem of increased pressure in the tank.

The cryogenic fluid boil-off mitigation system 100 can receive hydrogen via an intake mechanism 102 that couples to or is otherwise provided hydrogen from a hydrogen source 104. Additionally, the cryogenic fluid boil-off mitigation system can include a diverter valve 106 configured to control the distribution of hydrogen from the hydrogen source 104 within the cryogenic fluid boil-off mitigation system 100, a liquefaction system 108 comprised of two or more cooling stages (e.g., Cooling Stage One 110 and Cooling Stage Two 112) connected by an interstage conduit 114, and a storage tank 116. As noted above, the liquefaction system 108 can include a plurality of cooling stages, such as Cooling Stage One 110 and Cooling Stage Two 112, which can each include one or more cooling systems. Further, the diverter valve 106 and/or other components of the cryogenic fluid boil-off mitigation system 100 can be controlled by an intake controller 118 that regulates incoming hydrogen from the hydrogen source 104 and routes the incoming hydrogen to one or more destinations. As will be described in greater detail below, such destinations can include Cooling Stage One 110 along path A, Cooling Stage Two along path B, and/or the storage tank 116 along path C. Similarly, a tank controller 120 can be configured to regulate extraction of boil-off from the storage tank 116, and to direct the boil-off to Cooling Stage One 110 along path D. In some examples, the tank controller 120 is also configured to direct the boil-off to Cooling Stage Two 112 along path E. Accordingly, hydrogen (or another cryogenic fluid) can be stored for utilization by a backup power system 122 in the event that power demands associated with facility systems 124 cannot be satisfied by a primary power system 126, and the various configurations of the cryogenic fluid boil-off mitigation system 100 described herein can assist in avoiding the loss of hydrogen caused by boil-off.

The intake mechanism 102 can be any suitable mechanism by which hydrogen (or another cryogenic fluid) can be injected into and/or received by the cryogenic fluid boil-off mitigation system 100. In some examples, the hydrogen source 104 can include a delivery truck, a delivery pipeline, or any other suitable delivery means from an external hydrogen source. Additionally, the intake mechanism 102 can include valves, flanges, connectors, couplings, and other fastening means that enable the cryogenic fluid boil-off mitigation system 100 to be fluidly connected to the hydrogen source 104. Further, the intake mechanism can include temperature sensors (e.g., thermocouples, thermometers, etc.), pressure sensors (e.g., absolute pressure, gauge pressure, differential pressure, etc.), flow sensors (e.g., velocity flow, mass flow, etc.), and/or other sensors configured to identify properties of the incoming hydrogen. Similarly, the intake mechanism can include regulation systems for controlling the pressure and flow of hydrogen into the cryogenic fluid boil-off mitigation system 100 such as pumps (e.g., mechanisms configured to cause fluid flow, generate pressure differentials, and otherwise apply work to the fluid), control valves (e.g., valves that are configured to open to permit fluid flow and close to restrict fluid flow in response to a received signal and/or an applied force), throttling valves (e.g., valves that are utilize to control fluid flow rates and system pressure), and other pressure control and flow control systems. In some additional examples, the hydrogen received from the hydrogen source 104 can be in a mixed phase solution, in a gaseous state, or in a liquid state. Accordingly, the intake mechanism 102 can be configured to handle input fluids associated different phase states, to separate the gaseous phase from the liquid phase, and to route different phase states to the appropriate portion of the cryogenic fluid boil-off mitigation system 100. In some further examples, the hydrogen source 104 can be a hydrolysis system (e.g., a system configured to react water with a substance to produce at least hydrogen in a chemical process), an electrolysis system (e.g., a system configured to provide an electrical current that splits water into hydrogen and oxygen), and/or other hydrogen generation systems. In some hydrolysis reactions, the substance and the water can react such that a target molecule of the hydrolysis (or a parent molecule) gains a hydrogen ion. Additionally, hydrogen can be produced by the chemical reaction and supplied to the intake mechanism 102. It should be noted that the intake mechanism 102 can receive hydrogen in any form and facilitate input into the cryogenic fluid boil-off mitigation system 100.

The diverter valve 106 can be controlled, either remotely via electronic inputs, or directly via servos/motors, by an intake controller 118. The diverter valve can be configured to control fluid flowing between an input connector (e.g., pipe, hose, tube, etc.) and one or more output connectors. As noted above, one or more sensors (e.g., temperature sensor(s), pressure sensor(s), and flow sensor(s) that are components of the intake mechanism 102) can generate one or more signals associated with physical properties of the hydrogen received from the hydrogen source 104. The one or more signals can be transmitted to the intake controller 118 and utilized for the regulation and routing of the hydrogen. Alternatively, or in addition, the intake mechanism 102 can involve a delivery service such as a vendor of hydrogen that provides the hydrogen at a known pressure and a known temperature. In some examples, the intake controller 118 can be configured to monitor the temperature of the hydrogen relative to an inversion temperature of the hydrogen. It should be noted that the inversion temperature is the temperature where the Joule-Thomson coefficient of the hydrogen (or other cryogenic fluid) changes sign (e.g., the Joule-Thomson coefficient is negative at temperatures greater than the inversion temperature, causing the fluid to heat when expanded, and the Joule-Thomson coefficient is positive at temperatures lower than the inversion temperature, causing the fluid to cool when expanded). Accordingly, if the intake controller 118 determines that an input temperature of the hydrogen is above the inversion temperature, the intake controller 118 causes the diverter valve 106 to direct the hydrogen to Cooling Stage One 110 along path A. Similarly, if the intake controller 118 determines that the input temperature of the hydrogen is below the inversion temperature, the intake controller 118 causes the diverter valve 106 to direct the hydrogen to Cooling Stage Two 112 along path B. In some additional examples, the intake controller can determine that the hydrogen is below another threshold temperature lower than the inversion temperature, it can be diverted directly into the tank 116 along path C (e.g., the hydrogen is below the condensation point for a pressure of the hydrogen and is a liquid). In at least one example, the additional threshold temperature can be referred to as a storage temperature, wherein the storage temperature indicates a temperature at which the hydrogen can be safely introduced into the storage tank 116 without raising the temperature or pressure in the storage tank 116.

In some further examples, the intake controller 118 can cause the diverter valve 106 to regulate and route the hydrogen received from the hydrogen source 104 along Path A, Path B, and Path C based at least on one or more temperature thresholds, one or more pressure thresholds, one or more flow thresholds, or a combination of the various thresholds. In particular, the temperature and the pressure associated with the hydrogen received from the hydrogen source can be utilized to determine the thermal energy associated with the hydrogen and/or the amount of work required to cool the hydrogen from the temperature and pressure of the hydrogen source 104 to the temperature and pressure of the storage tank 116. Accordingly, the intake controller 118 can cause the hydrogen received from the hydrogen source 104 to be directed to Cooling Stage One 110 for initial cooling of the hydrogen and to Cooling Stage Two 112 for additional cooling and/or liquefaction.

The cryogenic fluid boil-off mitigation system 100 can include a liquefaction system 108. In particular, the liquefaction system 108 can include various components that reduce a temperature and/or a pressure of cryogenic fluids provided to the liquefaction system 108 at different temperatures, pressures, and/or states. In the example shown, the liquefaction system 108 includes Cooling Stage One 110 and Cooling Stage Two 112. Cooling Stage One 110 can utilize non-Joule-Thomson effect and Joule-Thomson cooling techniques (where the Joule-Thomson coefficient is negative) to reduce the temperature of the hydrogen 104 down to a threshold temperature and/or a threshold pressure of Cooling Stage Two 112. In some examples, the threshold temperature (and the threshold pressure) can be determined based at least on the inversion temperature of the cryogenic fluid (e.g., hydrogen), the storage temperature or the storage pressure of the storage tank 116, the boil-off temperature and the boil-off pressure associated with the boil-off of the storage tank 116, or other determined temperature and pressure associated with the cryogenic fluid boil-off mitigation system 100. Further, Cooling Stage Two 112 can utilize Joule-Thomson cooling techniques to further reduce the temperature of cryogenic fluid (e.g., the hydrogen received from hydrogen source 104).

In some examples, non-Joule-Thomson cooling techniques can include any refrigeration cycle capable of reducing the temperature of a fluid (e.g., gas, liquid, etc.) or non-cyclic refrigeration techniques. Refrigeration cycles can include vapor-compression cycles, absorption cycles, adsorption cycles, and other refrigeration techniques that cyclically utilize work to remove thermal energy from the system (e.g., cool the hydrogen received from the hydrogen source 104). Alternatively, or in addition, non-cyclic refrigeration involves the utilization of a working fluid that is dispersed or discarded after cooling (e.g., liquid nitrogen is relatively cheap and can be vented to atmosphere after utilization for refrigeration). As noted above, Cooling Stage One 110 can utilize non-Joule-Thomson techniques to cool the hydrogen received from the hydrogen source 104. Such techniques can utilize a heat exchanger having different fluids in various flow pathways that are brought into thermal contact with one another to transfer heat from one fluid to the other (optionally in a cyclic refrigeration system or non-cyclic refrigeration system). Some example types of heat exchangers are shell and tube heat exchangers, plate heat exchangers, plate and shell heat exchangers, adiabatic wheel heat exchangers, pillow plate hear exchangers, fluid heat exchangers, and dynamic scraped surface heat exchangers.

In some examples of Cooling Stage One 110, the non-Joule-Thomson cooling techniques are utilized to cool the hydrogen, or another low inversion temperature fluid (e.g., helium, neon, etc.), down to the inversion temperature. Reducing the temperature of the hydrogen below the inversion temperature enables the utilization of the Joule-Thomson effect to cool the hydrogen (or other cryogenic fluid). It should be noted that hydrogen and a few other materials have a somewhat unique characteristic that, in the gaseous phase, the inversion temperature is below room temperature (approximately 20° C.). Accordingly, Cooling Stage One 110 of the liquefaction system 108 can be configured to utilize non-Joule-Thomson effect cooling in Cooling Stage One 110 for all cryogenic fluids. Further, Cooling Stage One 110 of the liquefaction system 108 can be configured to utilize Joule-Thomson effect cooling in Cooling Stage One 110 for cryogenic fluids with inversion temperatures that are above the operating temperature of Cooling Stage One 110. The liquefaction system 108 can include an interstage conduit 114 passes the hydrogen from Stage One 110 to Stage Two 112 where Joule-Thomson effect cooling is performed to further reduce the temperature of the hydrogen 104.

Stage Two 112 of the liquefaction system 108 can employ Joule-Thomson cooling techniques to further reduce the temperature of the hydrogen received from the hydrogen source 104. In some examples, Joule-Thomson cooling techniques can be utilized to generate liquid hydrogen from the hydrogen that has been processed by Cooling Stage One 110. The Joule-Thomson effect (also known as the Joule-Kelvin effect or Kelvin-Joule effect) describes the temperature change of a real gas or liquid (as differentiated from an ideal gas) when it is forced through a valve or porous plug while keeping it insulated so that no heat is exchanged with the environment (e.g., the cryogenic fluid undergoes an adiabatic or substantially adiabatic expansion). This procedure is called a throttling process or Joule-Thomson process. At room temperature, most gases cooled upon expansion by Joule-Thomson techniques. However, and as noted above, some gases, such as hydrogen, helium, and neon have an inversion temperature below room temperature that causes them to heat upon expansion until the temperature of the gas is lowered below the inversion temperature. Accordingly, Joule-Thomson techniques can be used for hydrogen, helium, and neon once cooled below the inversion temperature. There are many ways to achieve the desired Joule-Thomson cooling, including nozzles, valves, or porous plugs and Cooling Stage Two 112 can include any number of these techniques. Further, Cooling Stage Two 112 can include a plurality of cooling operations. In some embodiments the multiple cooling operations can be stages to step down the temperature. In some embodiments there are multiple redundant cooling operations in Cooling Stage Two 112, and depending on the amount of hydrogen to be cooled, some portion of Cooling Stage Two 112 can be employed while another portion is idle.

In some examples, FIG. 1 is an illustration of the cryogenic fluid boil-off mitigation system 100 for a facility according to examples of the present disclosure. In particular, the cryogenic fluid boil-off mitigation system 100 can be configured to maintain a cryogenic fluid that can be utilized as a fuel by a backup power system 122. Additionally, the cryogenic fluid boil-off mitigation system can be configured to prevent venting of boil-off from the storage tank 116 from being vented to atmosphere by processing by re-liquefying the boil-off. Further, the cryogenic fluid boil-off mitigation system can be configured to maintain the cryogenic as a power reserve in the event that power demands of facility systems 124 is not met by a primary power system 126. In some additional examples, the primary power system 126 can be grid electricity from a local municipality or another standard source of primary power. Additionally, the facility systems 124 can be associated with a power demand that is determined based at least on the power consumed by various systems within the facility. Accordingly, the power demand can include the power requirements of any and all powered HVAC systems, lights, heating systems, cooling systems, motors, engines, networks, servers, other computing devices, and virtually any other mechanism that consumes electrical power within the facility.

Additionally, the cryogenic fluid boil-off mitigation system 100 can manage the cryogenic fluid for the backup power source 122 in the event of a power failure, shortage, or other circumstance that results in power demands of the facility systems 124 not being satisfied by the primary power system 126. In some examples, the backup power system 126 can include hydrogen-powered engine(s) and/or fuel cell(s) that convert hydrogen (or other cryogenic fuels) into sufficient energy to satisfy the power demands of the facility systems 124. Accordingly, upon determining that power demands are not being satisfied by the primary power system 126, the facility and/or the backup power system 122 can cause hydrogen to be extracted from the storage tank 116 and consumed to produce additional power for the facility systems 124.

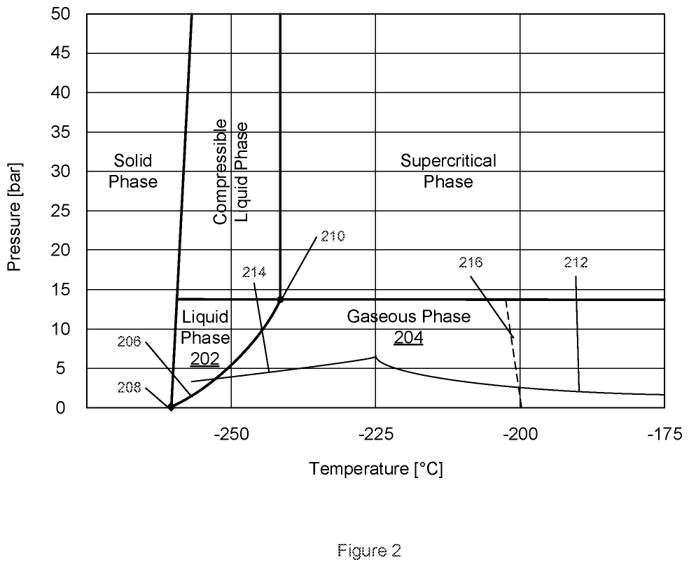

FIG. 2 is an illustration of a potential operating space for a cryogenic fluid boil-off mitigation system. In particular, FIG. 2 is an approximation of a phase diagram for diatomic hydrogen. However, it should be noted that FIG. 2 is an approximation and various values and bounding lines for individual phases may not exactly map to real world values. FIG. 2 includes an approximation of the temperatures and pressures where the liquid phase 202 can vaporize/evaporate into the gaseous phase 204, and the gaseous phase 204 can condense into the liquid phase 202. As shown in FIG. 2, an example vaporization curve 206 can represent the boundary between the liquid phase 202 and the gaseous phase 204 of the cryogenic fluid. For example, the vaporization curve 206 can represent the real-world temperature and pressure combinations where an atom or a molecule of the cyrogenic fluid can absorb the latent heat of vaporization, or emit the latent heat of condensation, and transition between the liquid phase 202 and the gaseous phase 204. Similarly, the example vaporization curve 206 can extend between a triple point 208 that represents the pressure and temperature where a cryogenic fluid exists in equilibrium between three states of matter (e.g., solid, liquid, and gas), and a critical point 210 that represents the pressure and temperature when the liquid phase 202 and the gaseous phase of the cryogenic fluid become a supercritical fluid. FIG. 2 includes an approximation of the triple point 208 and the critical point 210 of hydrogen, however, it should be noted that the triple point and critical point of other fluids can occur at other temperature and pressure combinations. Further, FIG. 2 includes a first curve segment 212 that represents a first temperature change and a first pressure change associated with the cryogenic fluid caused by a first cooling operation (e.g., a cooling operation performed by Cooling Stage One 110 of FIG. 1). Similarly, FIG. 2 includes a second curve segment 214 that represents a second temperature change and a second pressure change associated with the cryogenic fluid caused by a second cooling operation (e.g., a cooling operation performed by Cooling Stage Two 112 of FIG. 1).

It should be noted that despite the representation of the triple point 208 and the critical point 210 within FIG. 2, these phenomena have real world temperatures and pressures associated with them. In particular, the triple point of hydrogen, where the solid phase, liquid phase 202, and gaseous phase 204 exist in equilibrium, occurs at approximately 13.84 K/−259.31° C. and 7.04 kPa/0.0704 bar. Similarly, the critical point of hydrogen, where the liquid phase 202 and gaseous phase 204 cease to coexist and form a supercritical fluid, occurs at approximately 33.20 K/−239.95° C. and 1300 kPa/12.97 bar. Accordingly, the vaporization curve 206 represents the temperatures and pressures where hydrogen in the liquid phase 202 may vaporize into the gaseous phase 204 and hydrogen in the gaseous phase 204 may condense into the liquid phase 202.

In some examples, the cryogenic fluid boil-off mitigation system described above with respect to FIG. 1 can be configured to operate within the gaseous phase 204 and the liquid phase 202 of a cryogenic fluid, as represented in FIG. 2. In particular, Cooling Stage One 110 and Cooling Stage Two 112 can be configured to cool hydrogen received from the hydrogen source 104 from an input temperature, and liquefy the hydrogen for storage in the storage tank 116. Additionally, the first cooling operation of Cooling Stage One 110 can be represented by the first curve segment 212, where the temperature of the hydrogen is reduced from the input temperature of the hydrogen below a temperature threshold 216 associated with the changing of the Joule-Thomson coefficient from a negative value to a positive value. It should be noted that at atmospheric pressure, the Joule-Thomson coefficient changes from a negative value to a positive value at approximately 200 K/−73.15° C., though the temperature threshold 216 can be determined based at least in part on the pressure of the hydrogen. However, the first cooling operation associated with Cooling Stage One 110 can be configured to reduce the hydrogen below any temperature threshold with a temperature greater than the vaporization curve 206. Further, the first cooling operation can cause an increase in pressure (as illustrated by the first curve segment 212 of FIG. 2), occur in an isobaric environment, or cause a decrease in pressure based at least in part on the types of cooling method(s) utilized by Cooling Stage One 110. Similarly, the second cooling operation associated with Cooling Stage Two 112 can be configured to reduce the hydrogen from an output temperature of the first cooling operation to a storage temperature below the condensation temperature for a given pressure (as illustrated by the first curve segment 212 of FIG. 2).

In some examples, an additional cooling operation (not shown) can be included between the first cooling operation associated with the first curve segment 212 and the second cooling operation associated with the second curve segment 214. In particular, the first cooling operation can be configured to utilize non-Joule-Thomson cooling techniques to reduce the temperature of the hydrogen from the input temperature of the hydrogen source (e.g., a hydrogen tank, a hydrogen vendor, a hydrolysis system, an electrolysis system, etc.) to a first cooling operation output temperature that is below the temperature where the Joule-Thomson coefficient changes from a negative value to a positive value. Additionally, the non-Joule-Thomson cooling techniques may cause the pressure of the hydrogen to increase, remain constant, or decrease relative to the input pressure associated with the hydrogen source 104. After the first cooling operation, a pressurization operation (e.g., a pump) may increase the pressure from a first output pressure of the first cooling operation to an input pressure associated with the second cooling operation or the additional cooling operation. Accordingly, the additional cooling operation and the second cooling operation can utilize Joule-Thomson cooling techniques to cool the hydrogen and liquefy the hydrogen for storage. Further, additional pressurization operations may be included between the additional cooling operation, the second cooling operation, and/or a storage tank to maintain system integrity, safety, and operation parameters.

In some additional examples, the second cooling operation and, if included, the additional cooling operation can be configured to include one or more Joule-Thomson cooling operations (e.g., passing the hydrogen through a throttling valve, porous plug, or other pressure reducing device to cool the hydrogen) that reduce both the temperature and the pressure of the hydrogen, as illustrated by the second curve segment 214. Additionally, the second cooling operation can be configured to reduce the temperature of the hydrogen from a second cooling operation input temperature to a storage tank temperature, wherein the second cooling operation input temperature is associated with the first cooling operation output temperature or the additional cooling operation output temperature (optionally after the hydrogen output by the first cooling operation or the additional cooling operation is pressurized). Further, the second cooling operation can be further configured to receive hydrogen at a temperature and a pressure approximately equal to a boil-off temperature threshold and/or a boil-off pressure threshold of the storage tank. Accordingly, the second cooling operation can be configured to receive hydrogen at the second cooling operation input temperature and at a second cooling operation input pressure and reduce the temperature of the hydrogen to the storage temperature of the storage tank.

It should be noted that the cryogenic fluid boil-off mitigation system 100 (FIG. 1) can be configured such that the second cooling operation (e.g. Cooling Stage Two 112) can be configured to receive hydrogen from both previous cooling stages (e.g., first cooling operation represented by the first curve segment 212, the additional cooling operation, Cooling Stage One 110) and/or from a boil-off hydrogen source that collects gaseous hydrogen from the storage tank for reliquefaction by the second cooling operation. Additionally, support systems (e.g., pumps, valves, pressure regulators, temperature sensors, flow sensors, pressure sensors, etc.) can be associated with both hydrogen received from the hydrogen source 104 and from the boil-off hydrogen source such that the hydrogen received by the second cooling operation is at an appropriate pressure to enable cooling, via Joule-Thomson cooling techniques, from the second cooling operation input temperature to the storage temperature of the storage tank. Further, the second cooling operation can be configured to support the passive cooling of the storage tank (e.g., vaporization of liquid hydrogen to gaseous hydrogen within the tank removes the latent heat of vaporization from the liquid hydrogen and effectively cools the liquid within the storage tank) by receiving gaseous hydrogen due to sufficient amounts of boil-off being generated that a boil-off threshold related to temperature and/or pressure is satisfied. Accordingly, the boil-off hydrogen (e.g., gaseous hydrogen generated by boil-off) can be collected by a pump, or by a pipe that utilizes the internal pressure of the tank to drive the gaseous hydrogen, and transferred to the second cooling operation that can be configured to remove the latent heat of vaporization and liquefy the boil-off hydrogen for introduction to the storage tank.

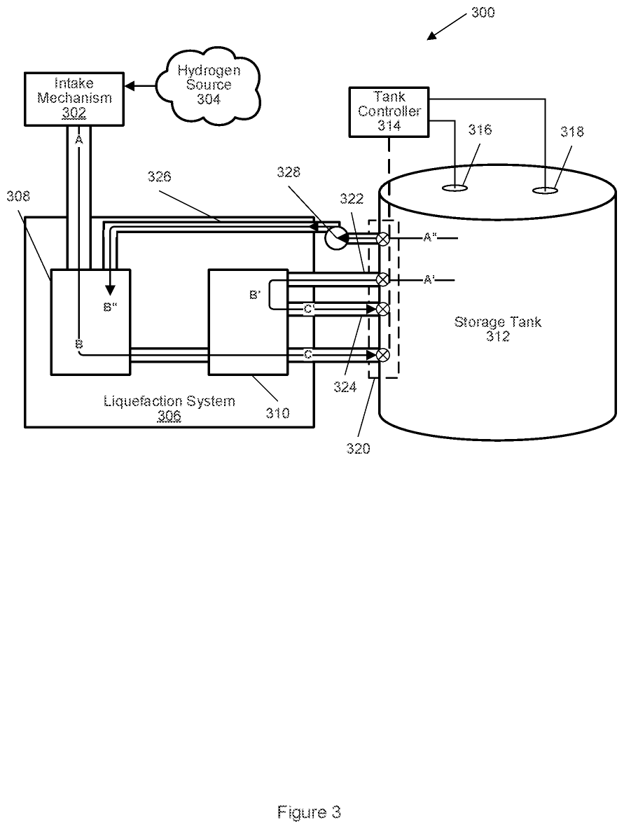

FIG. 3 is a schematic illustration of a cryogenic fluid boil-off mitigation system 300 according to further examples of the present disclosure. The cryogenic fluid boil-off mitigation system 300 can include many features discussed above with reference to FIGS. 1 and 2. In particular, the cryogenic fluid boil-off mitigation system 300 can include an intake mechanism 302 that receives hydrogen from a hydrogen source 304 and directs the hydrogen to a liquefaction system 306. The liquefaction system can include a plurality of cooling systems, including at least Stage One 308 and Stage Two 310, that cool and liquefy the hydrogen before input the liquid hydrogen into storage tank 312. Additionally, the storage tank 312 can be monitored by a tank controller 314 via at least a temperature sensor 316 and a pressure sensor 318. Based at least on information received from the temperature sensor 316 and/or the pressure sensor 318, the tank controller 314 can determine when boil-off hydrogen within the storage tank is to be cooled and liquified by Stage Two 312 of the cooling systems. The tank controller 314 can be configured to cause boil-off collection system 320 to collect boil-off hydrogen and transport the boil-off hydrogen to Stage Two 312 while liquid hydrogen return system 322 can receive the liquified hydrogen from Stage Two 312 and input the liquid hydrogen into storage tank 312.

The cryogenic fluid boil-off mitigation system 300 can utilize the intake mechanism 302 to regulate hydrogen received from the hydrogen source 304 where the hydrogen source does not regulate the hydrogen. In particular, the intake mechanism can include connector valves for pipes, hoses, and/or other connections with the hydrogen source that are controlled by an intake controller or by an operator associated with the cryogenic fluid boil-off mitigation system 300. The connector valves can include permanent connections with the hydrogen source 304 (e.g., for internal hydrogen source such as hydrolysis or electrolysis system and for external vendors that provide a pipeline to the facility) and/or temporary connections with the hydrogen source 304 (e.g., hydrogen source is a tank brought to the facility by truck and/or rail that connects to the intake mechanism and injects an amount of hydrogen). Independent of the nature of the hydrogen source 304, the intake mechanism can regulate input pressure (e.g., via throttling valves), regulate hydrogen flowrate, monitor input pressure (e.g., via pressure sensors), and monitor input temperature (e.g. via temperature sensors) through communications with various sensors associated with the intake mechanism 302 and signals transmitted to various components of the intake mechanism 302 (e.g., signals can control the amount of pressure reduction caused by throttling valves and/or the amount of pressurization caused by pumps). Accordingly, the input temperature, the input pressure, the input flowrate of hydrogen, and/or other physical properties of the hydrogen can be determined and transmitted to the liquefaction system 306.

As noted above, Stage One 308 may be substantially similar to and/or the same as Cooling Stage One 110 described with respect to FIG. 1. For example, stage 1 308 can utilize various cyclic refrigeration techniques (e.g. reverse Carnot cycle, reversed Stirling engines, vapor-compression cycle, heat exchanges associated with a working fluid, etc.) and/or noncyclic refrigeration techniques (e.g., liquid nitrogen passed through a heat exchanger and then vented to atmosphere) to cool the hydrogen to below a threshold temperature. Additionally, the initial cooling of the input hydrogen, by Stage One 308, received from the hydrogen source 304 can proceed according to the examples described by FIG. 1, with reference to Cooling Stage One 110. Additionally, Stage Two 310 may be substantially similar to and/or the same as Cooling Stage Two 112 described above with respect to FIG. 1. For example, Stage Two 310 can utilize Joule-Thomson cooling techniques to further cool and liquefy the hydrogen received from the hydrogen source 304 (similar to the techniques described by FIG. 1). Accordingly, hydrogen received from the hydrogen source 304 can be cooled, liquified, and input into the storage tank 312.

In some examples, the tank controller 314 can be configured to monitor at least a tank temperature and a tank pressure associated with the storage tank 312. In particular, the storage tank 312 can be a cryogenic storage tank that is configured to cryogenic liquids within a cryogenic environment (e.g., temperatures below −50° C.) and, optionally within a pressurized environment (although it should be noted that storage of hydrogen and other combustible cryogenic fluids is commonly under pressure to avoid leaks drawing oxidizing agents into the storage tank/the cryogenic fluid boil-off mitigation system 300). Accordingly, the storage tank 312 can be an insulated storage tank (such as Dewar flasks which are double walled containers that include high vacuum between the walls) that may include internal cooling systems (although these are commonly disincentivized by the additional thermal energy transfer enabled by internal cooling systems), one or more sensors for monitoring the stored cryogenic fluid, and one or more connectors that enable the stored cryogenic fluid to be extracted from and input into the storage tank 312. In some additional examples, the storage tank 312 can include fluid control devices 320 (e.g., valves, openings, etc.) that are operatively controlled by the tank controller 314. The fluid control devices 320 can be coupled to boil-off processing loops indicated by flows A′, B′, C′, A″, and B″. The fluid control devices 320 can include any combination of valve and pump that achieve the described objective of extracting boil-off hydrogen from the storage tank 312, optionally pressurizing the boil-off hydrogen (however, internal pressure of the storage tank 312 may be sufficient to drive the boil-off hydrogen along the flows A′, B′, C′, A″, and/or B″), and providing the boil-off hydrogen to cooling systems associated with Stage One 308 and/or Stage Two 310. A first fluid control device can be positioned and configured to regulate the flow of the boil-off hydrogen through flows A″ and B″, causing the boil-off hydrogen to be processed by the liquefaction system 306 in a manner analogous to the hydrogen received from the hydrogen source 304. Alternatively, or in addition, A second fluid control device and/or a third fluid control device can be positioned and configured to regulate the flow of fluid through Stage Two 310 and back into the storage tank 312. It is to be appreciated that for each of the fluid control devices 320 there may be any number of valve and/or pump involved to fully regulate the fluid flow, and that the location of the components may vary.

The hydrogen within the storage tank 312 can be a mixed phase solution comprised of liquid hydrogen (a majority of the hydrogen in the storage tank 312) and a small amount of hydrogen in a gas phase. As the hydrogen warms, the liquid hydrogen converts from the liquid phase into the gaseous phase. The tank controller 314 can be configured to detect when the storage temperature and/or the storage pressure of the hydrogen within the storage tank 312 satisfy (e.g., exceed) a temperature threshold and/or a pressure threshold that indicates boil-off hydrogen is to be processed and liquified. Accordingly, the boil-off hydrogen (e.g., hydrogen in the gaseous phase) can be extracted from the storage tank 312 and directed to Stage Two 310 of the liquefaction system 306 which can cool the boil-off hydrogen and can remove the latent heat of vaporization from the gaseous hydrogen, converting the gaseous phase back into a liquid phase, which is then returned to the storage tank 312. The overall temperature of the fluid in the storage tank 312 can be accordingly reduced and the boil-off waste can be minimized or completely eliminated.

As noted above, the tank controller 314 can be configured to monitor the storage temperature and the storage pressure of the hydrogen within the storage tank 312. In particular, the tank controller can monitor the storage temperature via the temperature sensor 316 and the storage pressure via the pressure sensor 318. The tank controller 314 can be configured to monitor the storage temperature and the storage pressure relative to one or more storage thresholds. These thresholds can be safety thresholds (e.g., internal pressure and/or temperature of the storage tank 312 is to remain below thresholds to prevent failure of the storage tank), efficiency thresholds (e.g., minimizing energy requirements to maintain hydrogen levels within the storage tank 312), and/or other thresholds determined on operational and/or business parameters. For example, a pressure threshold can be associated with a storage pressure that indicates an amount of hydrogen within the storage tank 312 has vaporized and that the storage pressure is approaching a pressure limit of the storage tank 312 (this may include safety factors). Accordingly, the tank controller 314 can detect that the pressure threshold has been exceeded by the storage pressure and cause the fluid control devices 320 to extract boil-off hydrogen (e.g., gaseous hydrogen) from the storage tank 312 via flow A′, direct the boil-off hydrogen to the Stage Two 310 cooling systems via flow B′, and return the liquified hydrogen to the storage tank 312 via flow C′. Additionally, an additional pressure threshold can be associated with an additional storage pressure that is greater than the pressure threshold and indicates that additional boil-off mitigation is to be performed. Accordingly, the tank controller 314 can detect that the additional pressure threshold has been exceeded and cause the fluid control devices to extract the boil-off hydrogen via flow A″, direct the boil-off hydrogen to the Stage One 308 cooling systems via flow B″, and return the liquified hydrogen to the storage tank 312. It should be noted that the tank controller 314 can be configured to operate the fluid control devices 320 to manage flow of boil-off hydrogen and can be connected to the fluid control devices 320 via electronic lines and/or via wireless control. Further, the tank controller 314 can communicate with the temperature sensor(s) 316 and the pressure sensor(s) 318 to receive storage tank data 322 via electronic lines and/or via wireless control.

The tank controller 314, temperature sensor 316, pressure sensor 318, and fluid control devices 320 can be configured to operate in concert to mitigate boil-off losses associated with the storage tank 312. If the two-phase mixture in the storage tank 312 is above a threshold temperature (e.g., the hydrogen inversion temperature at approximately 200 K), at which point the non-Joule-Thomson effect cooling is required, the tank controller 314 can cause the fluid control devices 320 to move boil-off hydrogen into the Stage One boil-off loop 326 so that Stage One 308 of the liquefaction system 306 can cool the fluid using non-Joule-Thomson effect cooling, then pass the fluid to Stage Two 310 for Joule-Thomson effect cooling, and eventually back into the storage tank 312. Alternatively, or in addition, the tank controller 314 can cause the fluid control devices 320 to utilize the Stage One boil-off loop 326 due to the storage pressure of the hydrogen exceeding a threshold that indicates an amount of cooling to liquefy the boil-off hydrogen exceeds a cooling capacity of Stage Two 310 cooling systems. Accordingly, the Stage One boil-off loop 326 can be configured to cool boil-off hydrogen that is over the inversion temperature of hydrogen and/or is associated with an amount of cooling that exceeds the capacity of Stage Two 310 by directing the boil-off hydrogen through both Stage One 308, Stage Two 310, and, optionally, any additional stages of cooling within the liquefaction system 306.

Additionally, the tank controller 314, temperature sensor 316, pressure sensor 318, and fluid control devices 320 can be configured to operate in concert to mitigate boil-off losses associated with the storage tank 312. If the two-phase mixture in the storage tank 312 is below a threshold temperature (e.g., the hydrogen inversion temperature at approximately 200 K) and above a threshold pressure, the tank controller 314 can cause the fluid control devices 320 to move boil-off hydrogen into the Stage Two boil-off input 322 and return the liquid hydrogen to the storage tank 312 via Stage Two boil-off output 324. In particular, Stage Two 310 of the liquefaction system 306 can cool the fluid using Joule-Thomson effect cooling and then pass the liquid hydrogen back into the storage tank 312. Alternatively, or in addition, the tank controller 314 can cause the fluid control devices 320 to utilize the Stage Two boil-off input 322 due to the storage temperature of the hydrogen satisfying a threshold that indicates an amount of cooling to liquefy the boil-off hydrogen is provided by the cooling capacity of Stage Two 310 cooling systems. Accordingly, the Stage Two boil-off input 322 can be configured to receive boil-off hydrogen that is below the inversion temperature of hydrogen and/or is associated with an amount of cooling that can be provided by Stage Two 310.

It should be noted that in some examples, the Stage Two boil-off input 322, the Stage Two boil-off output 324, and/or the Stage One boil-off loop 326 may include a pump 328 (depicted in association with the Stage One boil-off loop 326) configured to modify the pressure of the fluid from an output pressure of the storage tank 312 and/or Stage Two 310 to an input pressure of Stage One 308, Stage Two 310, and/or the storage tank 312. Accordingly, rotary pumps, piston pumps, diaphragm pumps, screw pumps, centrifugal pumps, and other pumps can be utilized to modify the pressure of the fluid based on the output pressure of one component of the cryogenic fluid boil-off mitigation system 300 and an input pressure of another component.

After reaching a desired temperature, pressure, and phase, the hydrogen can be passed through the Stage Two boil-off output 324 and/or the output of the liquefaction system 306 and into the storage tank 312. The storage tank 314 can hold the hydrogen until such time as the hydrogen is to be utilized to generate backup power, at which point the hydrogen can be transferred out of the storage tank 312. In some examples there can be a tank exit conduit hydrogen out of the storage tank 312. In some additional examples, the tank controller 314 can cause the hydrogen to be extracted from the storage tank 314 and cause the fluid control devices 322 to provide the hydrogen to a backup power system (e.g., backup power system 122).

In examples of the present disclosure the liquefaction system 306 can be utilized to maintain the hydrogen within the cryogenic fluid boil-off mitigation system 300 during long-term storage of hydrogen (e.g., longer than an hour, a day, a week, etc.). The cryogenic fluid boil-off mitigation system 300 can be configured to maintain the hydrogen within the storage tank, substantially as a liquid though some gaseous hydrogen can be stored, through Joule-Thomson cooling techniques utilized by Stage Two 310. The Joule-Thomson effect achieves cooling by allowing the hydrogen to expand through a throttling device, such as a valve or a nozzle, that causes the hydrogen to drop from a source pressure (provided by a pump and/or the storage tank) to a determined pressure under adiabatic conditions (e.g. an insulated throttling valve which is insulated to prevent heat transfer to or from the hydrogen) to cool the hydrogen. Accordingly, the tank controller 314 can manipulate the parameters of the process (e.g., pressure, flowrate, etc.) via the flow control devices 322 to achieve a desired cooling, return the hydrogen to the desired cryogenic temperatures, and to liquefy gaseous hydrogen if desired. In some examples, the Stage Two 310 cooling systems can be configured, by the tank controller 314 or other controller associated with the liquefaction system 306, to remove the latent heat of vaporization from the hydrogen. In other examples, the Stage Two 310 cooling systems can be configured to remove the latent heat of vaporization from the hydrogen and additional heat to achieve the desired temperature and/or pressure for the hydrogen to be input into the storage tank 312 via the Stage Two boil-off output 324. In at least one embodiment, the latent heat of vaporization can accounts for more than 95% of the energy consumed by Stage Two 310 (e.g., the work required to generate the pressure for causing the hydrogen to be cooled and/or liquified via pumps).

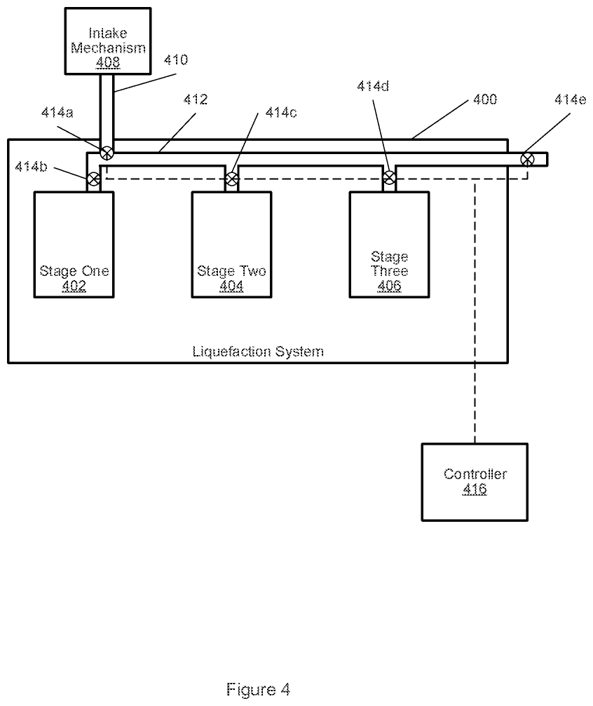

FIG. 4 is a schematic illustration of a liquefaction system 400 having three stages according to further examples of the present disclosure. It should be noted that the components shown in FIG. 4 may be similar to and/or the same as corresponding components described with reference to FIGS. 1 and 3. The liquefaction system 400 can include Stage One 402, Stage Two 404, and Stage Three 406. The liquefaction system 400 can include an intake mechanism 408 and an intake conduit 410 configured to receive and process hydrogen received from a hydrogen source (e.g., hydrogen source 104 and/or hydrogen source 304). The liquefaction system 400 can include conduits 412 that are configured to transport hydrogen to and/or from each of Stage One 402, Stage Two 404, Stage Three 406, and/or a storage tank (not pictured). Fluid control devices 414a-e are placed around the liquefaction system 400 to control fluid movement between the stages. The fluid control devices 414a-e can include any number of valves and/or pumps as needed to move fluid through the liquefaction system 400. Fluid control device 414a can be configured to control the intake conduit 410 and regulate the amount of hydrogen received by the liquefaction system from the hydrogen source. Fluid control devices 414b-d control fluid movement into and out of Stage One 402, Stage Two 404, and Stage Three 406, respectively. Fluid control device 414e controls fluid movement out of the liquefaction system 400, such as to the storage tank (not pictured). A controller 416 can be associated with the fluid control devices 414a-e and can be configured to generate signals for the fluid control devices 414a-e (e.g., where the fluid control devices are solenoid valves), actuate fluid control devices 414a-e (e.g., where the fluid control devices are pneumatic or hydraulic valves), actuate valves and/or pumps as needed to move hydrogen into and out of the liquefactions system 400, and actuate valves and/or pumps between Stage One 402, Stage Two 404, and Stage Three 406 as needed. The conduits 412 can include multiple branches and associated valves that fluidly connect the intake mechanism 408, Stage One 402, Stage Two 404, Stage Three 406, and the storage tank (not pictured). Accordingly, the conduits 412 can be configured to provide sufficient fluid pathways to selectively move hydrogen between the components of the liquefaction system 400 without compromising streams or mixing hydrogen from the different components unwantedly. Additionally, while the conduits 412 are illustrated as shared between all components, the conduits 412 can be divided into individual conduits that fluidly connect two components of liquefaction system 400.

In some examples the liquefaction system 400 can have any desired number of stages. The cryogenic systems herein can be used to treat hydrogen which has the somewhat unique characteristic of a negative Joule-Thomson effect as discussed above. Other cryogenic fluids have other characteristics that may require more stages that can apply different treatment principles to achieve an efficient cooling and liquefaction unit. Accordingly, each stage can be a different treatment mechanism. In other examples the stages can be redundant, operating the same liquefaction mechanisms on the fluid. Separating the liquefaction system 400 into a higher number of stages may permit a higher efficiency to be achieved. Accordingly, the liquefaction system 400 can be used at less than full capacity. One application of using a portion of the liquefaction system 400 is to remove the latent heat of vaporization from boil-off hydrogen. The hydrogen can then be returned to the tank or directed elsewhere for use, and this is achieved without requiring the entire liquefaction system 400.

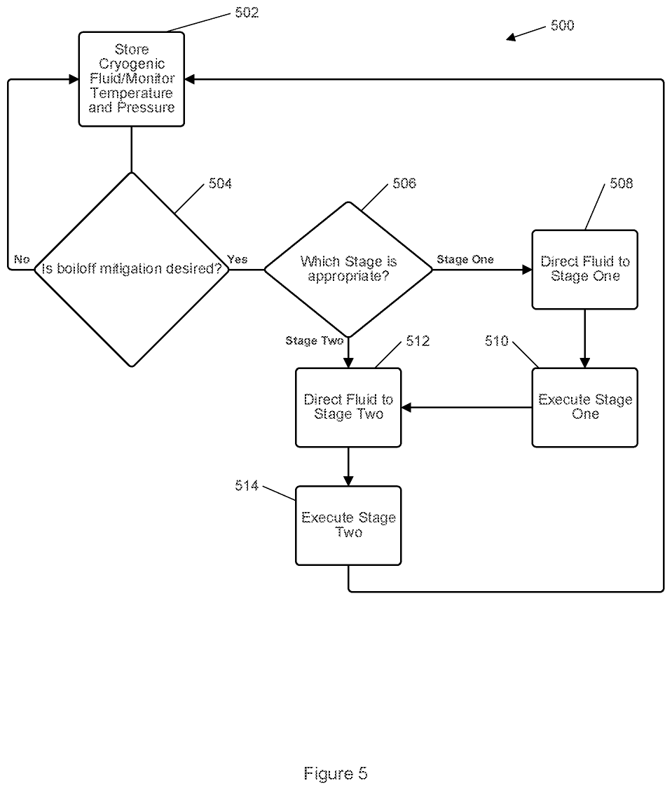

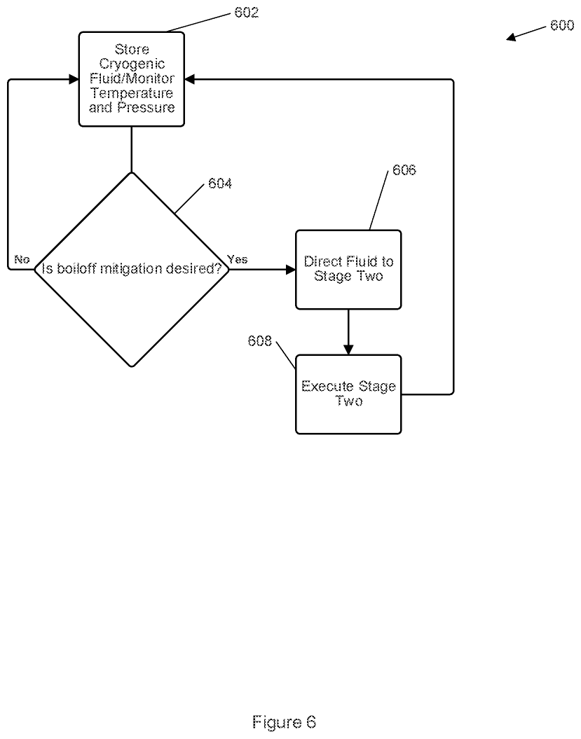

FIG. 5 is a block diagram of a method 500 according to examples of the present disclosure. The method 500 can be executed by one or more processors of a cryogenic fluid boil-off mitigation system as shown and described above with respect to FIGS. 1-4. For example, any of the methods described herein with respect to FIGS. 5 and 6 may be performed in whole, or in part, by one or more processors of the tank controller 120 (FIG. 1), the tank controller 314 (FIG. 3), the controller 416 (FIG. 4), and/or other control devices included in the cryogenic fluid boil-off mitigation systems described herein. Unless otherwise noted, such processor(s) will be described for the remainder of this disclosure without reference to the tank controller 120, 314, the controller 416, and/or other control devices noted above.

At 502, the processor(s) can manage the storage and maintenance of a cryogenic fluid, such as hydrogen, in a desirably cold and stable environment such as a storage tank. In particular, the processor(s) can receive a temperature, a pressure, and/or any other desirable parameter from one or more sensors connected at least to the storage tank. Additionally, the one or more sensors can be connected to the storage tank such that the temperature, the pressure, and/or other desirable parameters are determined from at least a liquid phase and/or a gaseous phase within the storage tank.

At 504, the processor(s) can determine whether boil-off hydrogen within the storage tank satisfies one or more pressure thresholds and/or one or more temperature thresholds. Additionally, the processor(s) can determine whether a boil-off mitigation operation is desired. It should be noted that the desirability of the boil-off mitigation operation can be based upon the one or more pressure thresholds, the one or more temperature thresholds, a schedule, and/or in response to direct intervention by an operator. If, at 504, the processor(s) determine, based at least on the temperature and/or the pressure of the storage tank, that the cryogenic fluid is within operational thresholds of the storage tank (e.g., within a temperature range and/or a pressure range that defines safe storage environments for an amount of the cryogenic fluid within the storage tank) (504—No), the processor(s) can return to monitoring the cryogenic fluid within the storage tank at 502. The check at 504 can be performed as often as practically desired or on a set schedule. For example, the check at 504 can be performed substantially continuously, periodically, and/or aperiodically.

On the other hand, if, at 504, the processor(s) determine, based at least on the temperature and/or the pressure of the storage tank, that the cryogenic fluid exceeds a temperature threshold and/or a pressure threshold associated with the storage tank (Step 504—Yes), the processor(s) may determine that boil-off cryogenic fluid is to be extracted from the storage tank and re-liquified via a liquefaction system. In particular, the temperature threshold and/or the pressure threshold can be associated with a maximum safe storage pressure (optionally including a safety factor) of the cryogenic fluid, a maximum safe storage temperature (optionally including an additional safety factor) of the cryogenic fluid, an amount of boil-off cryogenic fluid being stored within the tank, and/or other internal condition of the storage tank that causes the processor(s) to initiate boil-off mitigation. As noted above, the processor(s) can monitor the temperature and/or the pressure of the storage tank via one or more sensors that are connected to the storage tank and generate indications of pressure and/or temperature within the storage tank.

At 506 the processor(s) can perform a second check to determine cooling stage(s) that are to be utilized during the boil-off mitigation. As noted above with respect to at least FIGS. 1, 3, and 4, a liquefaction system can include one, two, or more stages in a given example of the present disclosure. Accordingly, the processor(s) can be configured to cause the liquefaction system to cool cryogenic fluid received from a cryogenic fluid source and boil-off cryogenic fluid extracted from a storage tank.

At 506, the processor(s) can determine that the boil-off cryogenic fluid exceeds a temperature threshold and determine that Stage One is appropriate. In particular, and as noted above, some cryogenic fluids, including hydrogen, have an inversion temperature that is below room temperature. Additionally, first cooling techniques for the cryogenic fluid may be ineffective at temperatures exceeding the temperature threshold and effective at additional temperatures lower than the temperature threshold. Alternatively, or in addition, second cooling techniques may be effective at for cooling the cryogenic fluids at both temperatures exceeding the temperature threshold and at additional temperatures below the temperature threshold. Accordingly, Stage One can be associated with at least the second cooling techniques that are effective at the temperatures exceeding the temperature threshold. Further, at 506, the processor(s) can determine that the boil-off cryogenic fluid satisfies the temperature threshold and determine that Stage Two is appropriate. Stage two can be associated with at least the first cooling techniques that are effective at the additional temperatures below the temperature threshold.

At 508, and if Stage One is appropriate (Step 506—Stage One), the processor(s) can cause one or more fluid control devices to extract boil-off cryogenic fluid from the storage tank and cause the one or more fluid control devices to provide the boil-off cryogenic fluid to the cooling operations of Stage One. In particular, the processor(s) can cause one or more pumps, valves, and/or other fluid control devices to extract boil-off cryogenic fluid from the storage tank and cause the boil-off cryogenic fluid to be provided to the cooling operations of Stage One via pipes, conduits, hoses, and/or other connections between the storage tank and the cooling operations of Stage One. In some examples, the pumps, valves, conduits, connections, and other fluid management components utilized to transport the boil-off cryogenic fluid between the storage tank and the cooling operations of Stage One can be configured according to the discussion of the Stage One boil-off loop 326 illustrated by FIG. 3. Additionally, at 510, the processor(s) can execute Stage One. In particular, the processor(s) can cause Stage One to reduce the boil-off hydrogen from a first temperature to a second temperature. Additionally, the processor(s) can be configured to moderate the amount of work utilized to cool the boil-off cryogenic fluid, moderate the amount of coolant/refrigerant utilized to cool the boil-off cryogenic fluid, and/or otherwise control the cooling operations in Stage One to cool the boil-off cryogenic fluid from the first temperature to the second temperature. In some examples, Stage One and Stage Two can be in series, meaning that fluid from Stage One proceeds to Stage Two. In other examples the fluid can be directed to Stage One and then discharged from the liquefaction system without reaching Stage Two. In other examples there may be a series of valves and controllers that direct the fluid from Stage One to either Stage Two or back to the tank as desired.

At 512, the processors can cause the fluid control devices to provide the boil-off cryogenic fluid to Stage Two and, at 514, cause the cooling operations of Stage Two to reduce the cryogenic fluid from the second temperature to a third temperature, where the boil-off cryogenic fluid is received from Stage One (Step 506—Stage One), or from the first temperature to the third temperature, where the boil-off cryogenic fluid is received from the storage tank (Step 506—Stage Two). In some examples, and as discussed above, the boil-off cryogenic fluid may be directed to Stage Two directly from the storage tank. Additionally, the processor(s) can cause the cooling operations of Stage Two to cool the boil-off cryogenic fluid from the first temperature, associated with the boil-off cryogenic fluid extracted from the storage tank, to the third temperature, associated with a temperature where the boil-off cryogenic fluid can be input into the storage tank. Further, the processor(s) can cause the cooling operations of Stage Two to liquefy the boil-off cryogenic fluid so that liquid cryogenic fluid is input into the storage tank. In some additional examples, the boil-off cryogenic fluid can be directed to Stage Two after the cooling operations of Stage One have completed. Accordingly, the processor(s) can cause the cooling Operations of Stage Two to cool, and to optionally liquefy, the boil-off cryogenic fluid received from Stage One and input the boil-off cryogenic fluid into the storage tank. After the cooling operations of Stage Two are complete, the processor(s) can cause the fluid control devices to return the boil-off cryogenic fluid, now liquid cryogenic fluid, to the storage tank and continue monitoring the storage tank and the cryogenic fluid at 502. If there were other Stages in the system, they could be factored into a proper order. The Stages may be serial to provide greater control over the cooling of boil-off cryogenic fluid (e.g., enabling cooling stages to cool across smaller temperature ranges), parallel to provide greater capacity control (e.g., parallel cooling operations can enable cooling stages to greater control throughput as some cooling operations may have minimum flow requirements), and/or in any combination of serial and parallel cooling stages.

Accordingly, the method of FIG. 5 enables the mitigation of boil-off losses for cryogenic fluids stored by the cryogenic fluid boil-off mitigation system as described by FIGS. 1-4. In particular, the constant detecting of internal temperatures and pressures of the storage tank enable processors of the cryogenic fluid boil-off mitigation system to track the amount of boil-off cryogenic fluid being generated and the amount of incoming heat being transferred between the atmosphere and the cryogenic fluid. Additionally, the detection of internal temperatures and pressures enables safety features to be implemented to ensure continued storage of the cryogenic fluid without incident. Accordingly, the processor(s) can cause cryogenic fluid that would otherwise be vented to atmosphere and lost for safety and maintenance reason to be extracted, liquified, and reintroduced to the storage tank. Further, the cyclical extraction, liquefaction, and reintroduction of the boil-off cryogenic fluid enables the long term storage of the cryogenic fluid and reduces the amount of cryogenic fluid that would be introduced into the storage tank from external sources.

FIG. 6 is a block diagram of a method 600 according to further examples of the present disclosure in which a single Stage is used for boil-off purposes. The method 600 can be executed by one or more processors of a cryogenic fluid boil-off mitigation system as shown and described above with respect to FIGS. 1-4. A cryogenic fluid boil-off mitigation system the present disclosure can include a liquefaction system controlled by the one or more processors. The liquefaction system can also include a dedicated boil-off management stage, depicted as Stage Two above. It is to be appreciated that the boil-off management stage may not be Stage Two in the process. At 602, the processor(s) can cause a cryogenic fluid, such as hydrogen, to be stored within a storage tank after being received from a cryogenic fluid source and cooled by the liquefaction system. The cryogenic fluid can be a mixed phase solution within the storage tank that exists in both a liquid phase and a gaseous phase. Additionally, the processor(s) can monitor the internal temperature and the internal pressure of the storage tank via one or more sensors (e.g., temperature sensors, pressure sensors, etc.). Accordingly, the process(s) can cause the cryogenic fluid to be stored and monitors the cryogenic fluid within the storage tank.

At 604, the processor(s) can determine whether a boil-off mitigation operation is desired. For example, as part of this determination the processor(s) may determine whether boil-off hydrogen within the storage tank satisfies one or more pressure thresholds and/or one or more temperature thresholds. It should be noted that the desirability of the boil-off mitigation operation determined at Step 604 can be determined based upon the one or more pressure thresholds, the one or more temperature thresholds, a schedule, and/or in response to direct intervention by an operator.

If, at 604, the processor(s) determine, based at least on the temperature and/or the pressure of the storage tank (stored at 602), that the cryogenic fluid is within operational thresholds of the storage tank (e.g., within a temperature range and/or a pressure range that defines safe storage environments for an amount of the cryogenic fluid within the storage tank) (Step 604—No), the processor(s) can return to monitoring the cryogenic fluid within the storage tank at 602. The check at 604 can be performed as often as practically desired or on a set schedule. For example, the check at 604 can be performed substantially continuously, periodically, and/or aperiodically.

On the other hand, if, at 604, the processor(s) determine, based at least on the temperature and/or the pressure of the storage tank (stored at 602), that the cryogenic fluid exceeds a temperature threshold and/or a pressure threshold associated with the storage tank (Step 604—Yes), the processor(s) may determine that boil-off cryogenic fluid is to be extracted from the storage tank and re-liquified via a liquefaction system. In particular, the temperature threshold and/or the pressure threshold can be associated with a maximum safe storage pressure (optionally including a safety factor) of the cryogenic fluid, a maximum safe storage temperature (optionally including an additional safety factor) of the cryogenic fluid, an amount of boil-off cryogenic fluid being stored within the tank, an inversion temperature of the cryogenic fluid, and/or other internal condition of the storage tank that causes the processor(s) to initiate boil-off mitigation. In at least one embodiment, extraction of the cryogenic fluid from the storage tank at temperatures greater than the inversion temperature may represent a safety issue due to the pressure drop caused by extracting the boil-off cryogenic fluid causing the remaining cryogenic fluid in the storage tank to heat. Accordingly, the temperature threshold can be selected or determined such that boil-off cryogenic fluid is extracted from the storage tank below the inversion temperature, and extraction of the boil-off cryogenic fluid cools the stored cryogenic fluid. As noted above, the processor(s) can monitor the temperature and/or the pressure of the storage tank via one or more sensors that are connected to the storage tank and generate indications of pressure and/or temperature within the storage tank.

At 606, the processor(s) can cause the cryogenic fluid to be extracted from the storage tank and provided to Stage Two by one or more fluid control devices. In particular, the processor(s) can be configured to operate (e.g. via electronic signals, pneumatic pumps, hydraulic pumps, etc.) valves (e.g., fluid control devices 320) to open fluid connections between the storage tank and cooling operations of Stage Two. Additionally, the processor(s) can be configured to cause pump(s) and/or the internal pressure of the storage tank to transport the boil-off cryogenic fluid from the storage tank to the cooling operations of Stage Two.

At 608 the processor(s) can determine an amount of cooling to be provided by the cooling operations of Stage Two. In particular, the processor(s) can cause the cooling operations of Stage Two to cool the cryogenic fluid from a first temperature to a second temperature and, optionally, to liquefy the cryogenic fluid. Additionally, the processor can cause one or more fluid control devices associated with Stage Two to return the cryogenic fluid to the tank or otherwise discharge the cryogenic fluid from Stage Two at the appropriate pressure and temperature. It should be noted that, Stage 608 can execute in a manner similar to Stage 514 such that the processor(s) cause the cooling operations of Stage Two (e.g. Joule-Thomson cooling operations) to cool the boil-off cryogenic fluid from a first temperature to a second temperature, liquefy the boil-off cryogenic fluid, and return the liquid cryogenic fluid to the storage tank. Similar to the extraction from the storage tank, the processor(s) can cause one or more fluid control devices (e.g., operate one or more valves and one or more pumps) to transport the liquid cryogenic fluid between the output of Stage Two and the input of the storage tank.

Accordingly, the method of FIG. 6 enables the mitigation of boil-off losses for cryogenic fluids stored by the cryogenic fluid boil-off mitigation system as described by FIGS. 1-4. In particular, hydrogen and other cryogenic fluids can be associated with an inversion temperature that is within the operation range of the liquefaction system utilized to liquefy input hydrogen from a hydrogen source for storage in the storage tank. Additionally, the inversion temperature can represent an operating range where Joule-Thomson cooling techniques do not cool hydrogen, but instead cause the hydrogen to heat. If improperly managed, extraction of hydrogen from the storage tank while the hydrogen would be heated by pressure drops can cause a potentially dangerous cycle of heating the stored hydrogen through extraction of boil-off hydrogen. Accordingly, the processor(s) associated with the cryogenic fluid boil-off mitigation system can be configured to prevent the stored hydrogen or cryogenic fluid from exceeding the inversion temperature and cool the boil-off hydrogen to ensure safe storage and maintenance of the stored hydrogen.

### INDUSTRIAL APPLICABILITY

In a large-scale facility such as a data center, backup power can be provided by hydrogen-driven engines (or fuel cells) that consume hydrogen as fuel to provide power to the facility. The hydrogen-driven engines (or fuel cells) can provide lower carbon emissions, cleaner emergency power, and alternative fuel sources when compared to diesel gensets commonly utilized as backup power. Storing hydrogen can involve precise control schemes and maintenance of the storage tank (e.g., storage temperature and storage pressure) because liquid hydrogen must be stored at very low temperatures. The systems and methods of the present disclosure provide a liquefaction system and a boil-off loop that can be utilized to reclaim boil-off hydrogen that would otherwise be vented to atmosphere. For example, the systems described herein include a Joule-Thomson cooling stage that enables relatively low power maintenance of stored liquid hydrogen and relatively low power reclamation of boil-off hydrogen that would otherwise be lost. The low power cooling stage (e.g., Joule-Thomson cooling stage) can be maintained in series with other, more power intensive cooling systems, but also be provided with an alternative input that enables boil-off hydrogen to be cooled on an as-needed basis.

As a result of the techniques described herein, the various systems of the present disclosure can mitigate or prevent hydrogen losses due to natural warming of the storage tank. The natural warming of the storage tank causes stored liquid hydrogen to boil-off into gaseous hydrogen that increases the internal pressure and temperature of the storage tank. Instead of venting the gaseous hydrogen (resulting in the need to regularly purchase or generate hydrogen), the boil-off hydrogen can be collected and processed by a portion of the liquefaction equipment. By passing the hydrogen through relatively low energy cooling systems (e.g., Joule-Thomson cooling systems), the hydrogen can be liquified and reintroduced to the storage tank. The described systems can accordingly mitigate the amount of hydrogen that is acquired from external sources, generated by internal source, or otherwise introduced into the backup power system. Further, the described systems can be configured to maintain the internal temperature and pressure of the storage tank within safety parameters. As a result, the disclosed systems are able to maintain a backup power source without suffering from the relatively high component costs, complexity, pollution, and frequent maintenance outages associated with known systems.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

1. A system, comprising:
a storage tank configured to store cryogenic hydrogen in a two-phase mixture;
a liquefaction system configured to receive hydrogen from an external source, the liquefaction system including a Joule-Thomson cooling stage and a non-Joule-Thomson cooling stage fluidly connected to the Joule-Thomson cooling stage, wherein the liquefaction system is further configured to:
receive the hydrogen at the non-Joule-Thomson cooling stage,
cool the hydrogen, at the non-Joule-Thomson cooling stage, to a first temperature below a temperature threshold,
transfer the hydrogen at the first temperature from the non-Joule-Thomson cooling stage to the Joule-Thomson cooling stage,
cool the hydrogen, at the Joule-Thomson cooling stage, to a second temperature less than the first temperature, and
transfer the hydrogen at the second temperature from the Joule-Thomson cooling stage to the storage tank; and
a boil-off loop configured to transfer boil-off hydrogen from the storage tank to the Joule-Thomson cooling stage of the liquefaction system, the Joule-Thomson cooling stage being configured to:
cool the boil-off hydrogen to a third temperature, and
transfer the cooled boil-off hydrogen, at the third temperature, to the storage tank.

2. The system of claim 1 wherein the boil-off loop is configured to increase a pressure of the boil-off hydrogen to a first pressure above a pressure threshold associated with the Joule-Thomson cooling stage.

3. The system of claim 1, further comprising a controller operably connected to one or more fluid control devices, the controller being configured to:
receive, from at least one of a temperature sensor associated with the storage tank and a pressure sensor associated with the storage tank, at least one of a temperature of hydrogen disposed within the storage tank and a pressure of hydrogen disposed within the storage tank;
determine at least one of:
the temperature of the hydrogen disposed within the storage tank exceeds a temperature threshold, and
the pressure of the hydrogen disposed within the storage tank exceeds a pressure threshold; and
cause, based at least on the determining, the one or more fluid control devices to transfer the boil-off hydrogen to the boil-off loop.

4. The system of claim 3, wherein the liquefaction system further comprises a third stage, and wherein the controller is configured to cause the one or more fluid control devices to transfer the boil-off hydrogen to one or more of the non-Joule-Thomson cooling stage, the Joule-Thomson cooling stage, or the third stage.

5. The system of claim 1, further comprising a controller configured to:
cause a flow control device fluidly connected to the boil-off loop to direct the boil-off hydrogen to the non-Joule-Thomson cooling stage, and
cause the non-Joule-Thomson cooling stage to direct the boil-off hydrogen to the Joule-Thomson cooling stage via a fluid passage extending from the non-Joule-Thomson cooling stage to the Joule-Thomson cooling stage.

6. The system of claim 1 wherein the Joule-Thomson cooling stage is configured to remove a latent heat of vaporization from the boil-off hydrogen, and to return liquified hydrogen to the storage tank.

7. A system, comprising:
a storage tank configured to store a fluid, in a cryogenic state, below a cryogenic temperature threshold and below a cryogenic pressure threshold;
a liquefaction system having a first stage, and a second stage fluidly connected to the first stage, the liquefaction system being configured to:
receive the fluid at the first stage,
reduce a temperature of the fluid to a storage temperature below the cryogenic temperature threshold, and
transfer the fluid, at the storage temperature and via a first fluid passage, from the second stage to the storage tank;
a second fluid passage fluidly connecting the storage tank with the second stage; and
a controller operably connected to the liquefaction system and to one or more fluid control devices, wherein the controller is configured to:
cause the one or more fluid control devices to transfer boil-off fluid from the storage tank to the second stage of the liquefaction system,
cause the second stage of the liquefaction system to liquefy the boil-off fluid, and
cause the one or more flow control devices to transfer the liquified boil-off fluid from the second stage of the liquefaction system to the storage tank.

8. The system of claim 7 wherein the first stage comprises a non-Joule-Thomson cooling stage and the second stage comprises a Joule-Thomson cooling stage.

9. The system of claim 7 wherein the fluid comprises hydrogen, and the cryogenic temperature threshold comprises an inversion temperature of hydrogen and associated with Joule-Thomson cooling techniques.

10. The system of claim 7, wherein the one or more fluid control devices comprise a valve operably connected to the controller and configured to control transfer of the boil-off fluid from the storage tank to the second stage of the liquefaction system.

11. The system of claim 10, wherein the one or more fluid control devices further comprise a pump operably connected to the controller and configured to at least one of
transfer the boil-off fluid from the storage tank to the second stage of the liquefaction system, and
transfer the liquified boil-off fluid from the second stage of the liquefaction system to the storage tank.

12. The system of claim 11 wherein the pump is further configured to increase a pressure of the boil-off fluid from a first pressure to a second pressure associated with the second stage of the liquefaction system and greater than the first pressure.

13. The system of claim 7, the liquefaction system further comprising a third stage fluidly connected to the second stage, the third stage being configured to utilize non-Joule-Thomson cooling techniques to cool the boil-off fluid to an input temperature associated with the second stage of the liquefaction system.

14. The system of claim 13, wherein the third stage is implemented in parallel with the first stage such that the fluid is cooled by the first stage and the second stage, and the boil-off fluid is cooled by the third stage and the second stage.

15. A method, comprising:
determining, with a first sensor associated with a storage tank, a temperature of hydrogen stored within the storage tank;
determining, with a second sensor associated with the storage tank, a pressure of the hydrogen;
determining, with a controller operably connected to the first sensor and the second sensor, at least one of:
the temperature of the hydrogen exceeds a temperature threshold, and
the pressure of the hydrogen exceeds a pressure threshold;
causing, with the controller and based at least in part on determining the at least one of the temperature of the hydrogen exceeds the temperature threshold and the pressure of the hydrogen exceeds the pressure threshold, a first flow control device operably connected to the controller to direct boil-off hydrogen from the storage tank to a liquefaction system fluidly connected to the storage tank, the liquefaction system including:
a first stage configured to execute non-Joule-Thomson cooling techniques, and
a second stage fluidly connected to the first stage, the second stage being configured to execute Joule-Thomson cooling techniques; and
causing, with the controller, a second flow control device operably connected to the controller to transfer liquid hydrogen from the second stage of the liquefaction system to the storage tank.

16. The method of claim 15, further comprising:
determining, with the controller, that the temperature of the hydrogen is greater than a coefficient temperature threshold; and
causing, with the controller and based at least on determining that the temperature of the hydrogen is greater than the coefficient temperature threshold, the first fluid control device to transfer the boil-off hydrogen to the first stage of the liquefaction system.

17. The method of claim 15, further comprising:
determining, with the controller, that the temperature of the hydrogen is less than a coefficient temperature threshold; and
causing, with the controller and based at least on determining that the temperature of the hydrogen is less than the coefficient temperature threshold, the first fluid control device to transfer the boil-off hydrogen to the second stage of the liquefaction system.

18. The method of claim 15 wherein the liquefaction system comprises a third stage configured to execute Joule-Thomson cooling techniques, and fluidly connecting the first stage with the second stage, the method further comprising directing at least a portion of the boil-off hydrogen to the third stage based at least on the temperature of the hydrogen and the pressure of the hydrogen.

19. The method of claim 15 wherein the liquefaction system comprises a third stage configured to execute Joule-Thomson cooling techniques, and fluidly connecting the first stage with the storage tank, the method further comprising directing at least a portion of the boil-off hydrogen to the second stage and the third stage based at least on the temperature of the hydrogen and the pressure of the hydrogen.

20. The method of claim 15, further comprising:
receiving, with the controller, an instruction from a remote source to direct the hydrogen to the first stage or the second stage of the liquefaction system; and
causing, with the controller and based at least in part on the instruction, the first fluid control device to transfer the boil-off hydrogen from the storage tank to the first stage or the second stage of the liquefaction system.
